(19) United States
(12) Patent Application Publication
(10) Pub. No.: US 2024/0416353 A1
(43) Pub. Date: Dec. 19, 2024

(54) HIGH-PRESSURE ROLL PRESS WITH VIBRATION DEVICE IN THE FEEDER DEVICE

(71) Applicant: KHD HUMBOLDT WEDAG GMBH, Cologne (DE)

(72) Inventors: Niko HACHENBERG, Overath (DE); Hans-Peter JESCHINOWSKI, Siegburg (DE); Matthias MERSMANN, Stolberg (DE); Feleke TAMIRU, Köln (DE); Kai WEIDER, Köln (DE)

(21) Appl. No.: 18/010,683

(22) PCT Filed: Jun. 15, 2021
(86) PCT No.: PCT/EP2021/066072

§ 371 Date: Aug. 3, 2023

(30) Foreign Application Priority Data
Jun. 16, 2020 (DE) 10 2020 115 891.2

(51) Int. Cl. B02C 4/28; B02C 4/02; B02C 4/42; B02C 25/00

(52) U.S. Cl. CPC B02C 4/286; B02C 4/02; B02C 4/423; B02C 25/00

(57) ABSTRACT

A high pressure roll press has two counter-rotating rolls configuring a roll nip through which milling material passes and is comminuted under high pressure by forming a fracture in a milling material structure in the roll nip. A feeder device feeds the milling material homogeneously onto the roll nip. The volume of the fed milling material configures a compaction zone, which reaches from approximately the center of the roll nip to just beyond the center of the roll nip. A vibration device for pre-compressing the milling material is arranged above the compaction zone, reaching into the compaction zone. A metering slide is arranged within the feeder device to set the feeding location and the feeding quantity of the milling material onto the roll nip. The vibration device is connected to the metering slide, wherein the metering slide conducts the vibration energy of the vibration device into the compaction zone.

### CROSS-REFERENCES TO RELATED APPLICATIONS

This application claims the benefit of the International Application No. PCT/EP2021/066072, filed on Jun. 15, 2021, and of the German patent application No. 102020115891.2 filed on Jun. 16, 2020, the entire disclosures of which are incorporated herein by way of reference.

### FIELD OF THE INVENTION

The invention relates to a high-pressure roll press for the high-pressure comminution of milling material in a roll nip, having two counter-rotating rolls which configure a roll nip through which the milling material to be comminuted passes during comminution under high pressure, in the process configuring in the roll nip a fracture in the structure of the milling material, and a feeder device which feeds the milling material uniformly onto the roll nip, wherein the volume of the fed milling material configures a compaction zone which extends from approximately the center of the roll nip to just beyond the center of the roll nip, wherein a device for pre-compacting the milling material, in the form of a vibration device, is disposed above the compaction zone and extends to close to the compaction zone, and wherein a metering slide, with the aid of which the feeding location on the roll nip and the quantity of the milling material fed onto the latter is adjustable, is disposed within the feeder device.

### BACKGROUND OF THE INVENTION

According to Schonert, DE 27 08 053 C3, for the comminution of brittle material it is known for the latter, by way of being subjected to high pressure in the roll nip of a high-pressure roll press, to be pressed into so-called slugs, wherein the entire material structure fractures and as a result is divided into many small fragments. This high-pressure comminution in the roll nip differs from comminution by shearing or grinding, as takes place in a conventional mill, because the primary emphasis is on being subjected to pressure. No shearing or grinding of the milling material takes place. In order for the corresponding high-pressure roll press to be able to operate as intended, it is important that the roll nip is uniformly impinged with milling material, because the high-pressure roll press in the absence of uniform impingement changes to the operating state of a conventional crusher, the comminution effect of the latter being different from that of a high-pressure roll press which is uniformly impinged with milling material.

If the milling material is mixed with air in a non-homogenous manner, the milling material when passing through the roll nip has the option of diverting into the air space and thus of evading the high pressure in the roll nip, as a result of which the comminution performance of the high-pressure roll press is significantly reduced. Furthermore, this as a result can cause the high-pressure roll press to run unevenly in that the rolls perform a rotating vibration because the drive of the rolls of the high-pressure roll press repeatedly changes from deceleration to freewheeling. This abrupt load change is propagated in the entire high-pressure roll press and can be perceived as a vibration of the entire high-pressure roll press. In the case of unfavorable conditions, the vibration may propagate into the foundation and in unfavorable circumstances even damage the foundation.

In order for the roll nip to be uniformly impinged with milling material for uniform and smooth running of the high-pressure roll press, feeder devices for milling material which vary the supply of the milling material with feedback control such that a constant bulk material cone is configured in the space between the two counter-rotating rolls in such a high-pressure roll press are known. However, depending on the type and consistency of the milling material, this type of impingement of the roll nip is insufficient for guaranteeing vibration-free running of the rolls of the high-pressure roll press and for achieving a continuous operating mode of the entire comminution machine as a high-pressure roll press. A non-uniform distribution of grain in the milling material, and air pockets in the bulk produce cannot always be homogenized to a sufficient extent solely by feedback-controlling the bulk material cone in the space between the counter-rotating rolls.

In the German utility model DE 20 2009 014 079 U1 it is proposed that vibration rods, such as are known as concrete vibrators in concrete casting technology, are disposed in the feeder device, the vibration rods extending to close to the compaction zone of the milling material to be comminuted. The vibration rods ventilate the milling material by fluidizing the latter, thus ensuring smoother running. During actual operation it has been demonstrated that the vibration rods do not withstand the rough conditions in the high-pressure roll press. The vibration rods are too rapidly worn out or even bent by the milling material. The service life of concrete vibrators, or of metal rods which are set in vibration with the aid of the concrete vibrator, is insufficient in order to guarantee a sufficiently long operation without downtime of the high-pressure roll press.

### SUMMARY OF THE INVENTION

It is, therefore, an object of the invention to provide an alternative for the known concrete vibrators for fluidizing the milling material in the feeder device. This object according to the invention is achieved in that the vibration device is connected to the metering slide, wherein the metering slide directs the vibration energy into the compaction zone.

It is essential to the invention that the milling material which impinges the high-pressure roll press is compacted shortly before and while entering the compaction zone in that enclosed air is evacuated from the milling material, the compaction zone not having any very sharp boundary lines. The compaction zone, from the center of the roll nip, extends in a region across the roll nip where the intake of the milling material as a result of the milling material disappearing downward leads to a flowing movement, wherein the free volume of the milling material is reduced, the density of the milling material being increased as a result. In order for this effect to be supported, it is provided that a device for pre-compacting is disposed exactly there.

According to the concept of the invention, the device for compacting is a vibration device which is connected to a metering slide that is present anyway. Instead of rods that extend into the feeder device and direct the vibration energy into the milling material, it is provided according to the concept of the invention that the metering slide vibrates and directs the vibration energy into the milling material, thus setting the loose milling material in vibration. As a result of the vibrations, the milling material behaves as if it had been fluidized. The vibration device thus has the effect of improving the flow of the milling material, because the particles of milling material are kept in a movement similar to that of a fluid bed as a result of the vibration. As a result of the vibrations, the individual particles of milling material in the fluid bed drop downward in the direction of the roll nip, and air dispersed in the milling material escapes from the milling material upward, through the inflowing milling material, into the free atmosphere.

The vibration device can be disposed on the side of the metering slide that faces outward and set the metering slide in vibration. In this way, the metering slide assumes the function of a vibration tray.

In order to increase the energy input into the milling material, it can be provided that fin-shaped extensions which direct the vibration energy into the milling material close to the compaction zone are disposed on the side of the metering slide that faces the milling material. In the simplest case, these extensions are, for instance, triangular or rhomboid fins which stand like vertical baffles on the surface of the metering slide. Depending on the width of the milling roll, only one fin-shaped extension or else two, three or more fin-shaped extensions, can be disposed so as to be approximately mutually parallel.

The size of the energy input into the milling material as a result of the vibration is also relevant in terms of the effectiveness of the fluidization. During operation it has proven advantageous for the mechanical energy input to be between 0.1 KJ/m³ and 10 KJ/m³ and more preferably between 0.1 KJ/m³ and 1 KJ/m³ of milling material. If the milling material in a circulation mill or a recirculation mill is rather fine, a minor energy input into the fine milling material is sufficient. However, the energy input in the case of a very fine milling material can be achieved only by way of a high surface of the vibration device. In the case of coarser milling material, for example in a circulation mill having a lower circulation rate, the energy input has to be higher. However, the mechanical energy input is more easily achievable in the case of coarser milling material. This is again different in the case of milling material with a very wide distribution in terms of grain size, when very fine milling material from the circulation is mixed with coarse milling material from the fresh material infeed. For non-homogenous milling material, it has proven advantageous for the energy input to be varied by feedback-controlling the performance. In order to optimize the effect of the vibration device it is possible to feedback-control the vibration intensity and thus the actual mechanical energy input by a feedback-control loop, wherein the energy consumption of the vibration device is chosen as the input parameter. If the energy consumption is high, or higher than a previously determined target value, the feedback-control device causes a reduction of the vibration intensity, since the vibration device operates without any further compaction effect in the compacted material such that the mechanical energy input into the milling material is unnecessarily increased. The reduction of the vibration intensity has the consequence that fresh, non-compacted material flows in during the ongoing operation of the high-pressure roll press, the mechanical energy input thus being reduced again and indicating a lower density of the milling material above and at the beginning of the compaction zone. In this case, the feedback-control device feedback-controls the vibration device back to an operating state with increased intensity until a stationary equilibrium between the vibration intensity of the vibration device and the energy consumption of the latter, from which the milling material density can be derived, is established. The energy consumption and the actual mechanical energy input into the milling material are indeed correlated. However, the grain size distribution and the milling material characteristics, for example fluidized to a different degree by variable moisture or by different air pockets, can influence the actual mechanical energy input at a constant energy consumption of the vibration device.

In order to form a feedback-control loop, the energy consumption of the device for compaction per se can be used as an input variable. It is also expedient for the energy consumption of the roll drive to be utilized as a control input variable, since an increased energy consumption indicates a higher bulk produce density of the milling material, and a lower energy consumption of the roll drive indicates a lower bulk produce density of the milling material. In the case of this feedback-control principle, it has to be noted that passes of comparatively large milling material particles, or of materials which cannot be comminuted by high pressure, such as metal pieces, which generate a brief increased energy consumption of the milling roll drive, are incorporated in the feedback-control loop, so as to prevent a propagation of the interference by the passage of the non-comminutable milling material particle in the high-pressure roll press as a result.

The milling roll speed can be an even further control input variable. The faster the roll of the high-pressure roll press rotates, the more intensively the device for compaction has to operate, presently the vibration device has to vibrate, in order to compact the milling material in a shorter time, the latter now flowing more rapidly into the roll nip.

The energy input can be influenced by increasing the vibration amplitude of the vibration device, as well as the frequency of the vibration. Depending on the construction mode, the frequency may be variable by varying the excitation frequency in electrically excited vibration devices. Varying the frequency is typically also possible in pneumatic vibration devices. The operating frequency of customary and commercially available concrete vibrators can be adjusted in the range between 800 min−1 (approx. 13 Hz) and 9000 min−1 (150 Hz). It has proven particularly effective as an excitation frequency for fluidizing the milling material for the vibration frequency to be between 10 Hz and 60 Hz.

Excitations at a lower frequency in the range of 10 Hz are suitable for loosening comparatively coarse milling material particles. However, the lower frequency, which may possibly be a resonance frequency or natural frequency of the metering slide, can represent a particular load for the mechanism or the hydraulics of the metering slide. Higher frequencies such as, for example, 50 Hz or 60 Hz, which are customary electric grid frequencies, are suitable for loosening comparatively fine milling material. These frequencies are typically much higher than natural frequencies of the mechanical construction of the metering slide and thus represent lower mechanical loads for the metering slide.

In a particular design embodiment of the invention it is provided that the vibration device can be manually actuated in order to actuate the vibration device in the event of potential malfunctions of the roll of the high-pressure roll press or in the event of a blocked flow of the milling material, as a result of which the material flow of the milling material is initiated again.

### BRIEF DESCRIPTION OF THE DRAWINGS

The invention will be explained in more detail by means of the following figures in which:

FIG. 1 shows a schematic lateral view of a high-pressure roll press, having a metering slide with a vibration device;

FIG. 2 shows a metering slide as is used in the high-pressure roll press according to FIG. 1, having fin-shaped extensions;

FIG. 3 shows a metering slide as is used in the high-pressure roll press according to FIG. 1, having alternative fin-shaped extensions;

FIG. 4 shows a schematic lateral view of a further high-pressure roll press, having an alternative metering slide with a vibration device;

FIG. 5 shows a metering slide as is used in the high-pressure roll press according to FIG. 4, having alternative fin-shaped extensions and wear strips; and

FIG. 6 shows a vibration diagram which shows the effect of the vibration device.

### DETAILED DESCRIPTION OF THE PREFERRED EMBODIMENTS

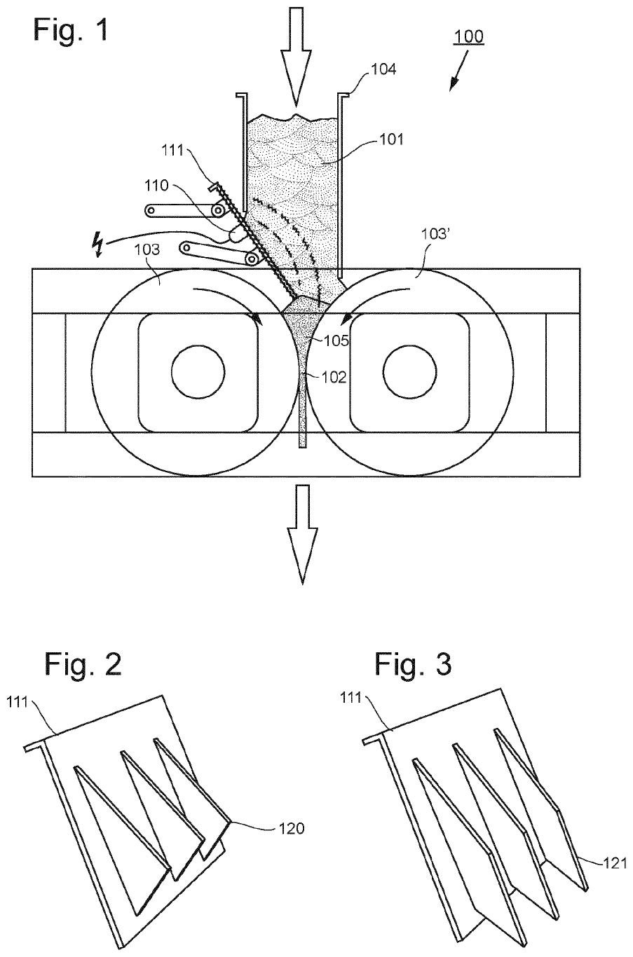

Illustrated in FIG. 1 is a schematic lateral view of a high-pressure roll press 100 having a metering slide 111. A vibration device 110 which sets the metering slide 111 in vibration is fastened to the metering slide 111. Milling material 101 in a feeder device 104 is fluidized by the vibrating metering slide 111. Trapped air L escapes from the milling material 101 in the process. The metering slide 111, depending on the position, extends to close to the compaction zone 105, the latter here being highlighted by the pattern and the border within the milling material 101. The milling material 101 is pulled through the roll nip 102 by the two counter-rotating rolls 103 and 103′, the milling material configuring a fracture in the structure and being comminuted in the process in said roll nip 102.

An alternative design embodiment of the metering slide 111 is illustrated in FIG. 2. The metering slide 111 has fin-shaped extensions 120 which like baffles stand vertically on the surface of the metering slide 111. The extensions 120 direct the vibration energy into the milling material 101. Because the metering slide 111 is variable in terms of its position, the extensions 120 follow the metering slide 111.

A further alternative design embodiment of the metering slide 111 is illustrated in FIG. 3. The metering slide 111 illustrated here has fin-shaped extensions 121 which likewise like baffles stand vertically on the surface of the metering slide 111. The extensions 121 direct the vibration energy into the milling material 101. Because the metering slide 111 is variable in terms of its position, the extensions 121 follow the metering slide 111. The extensions 121 are, in particular, constructed in the shape of rhomboids and by way of a projection on the foot of the extensions 121 extend closer to the compaction zone 105.

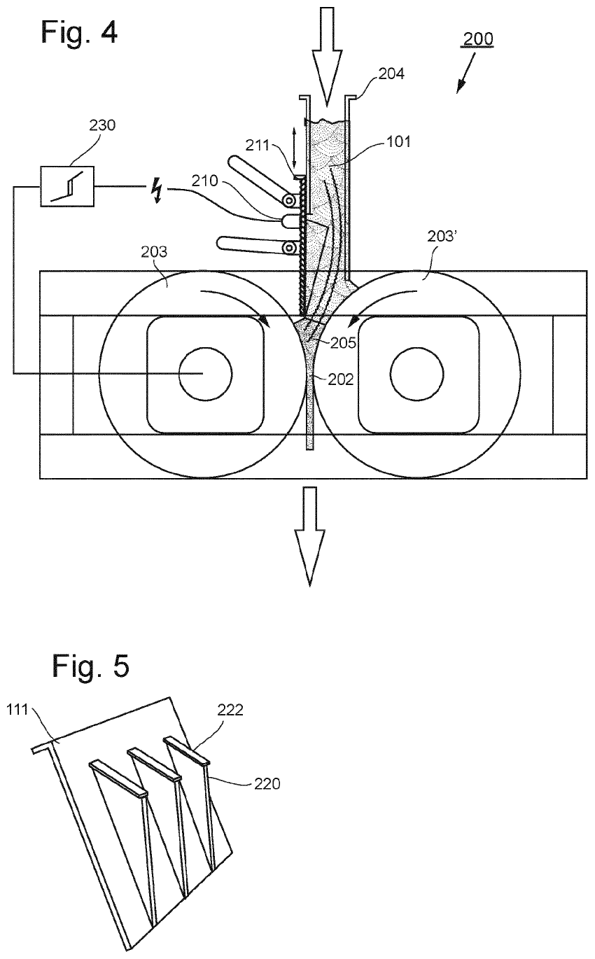

A schematic lateral view of a further high-pressure roll press 200 having an alternative metering slide 211 with a vibration device 210 is shown in FIG. 4. The metering slide shown here can be adjusted for height like a level regulator in a reservoir. The vibration device 210 by way of the metering slide 211 delivers vibration energy into the milling material 101 in the feeder device 204. In the process, air L escapes from the milling material at the location indicated, specifically between the metering slide 211 and the adjacent wall of the feeder device. Depending on the position, this metering slide 211 also extends right up to the compaction zone 205, the latter here being highlighted by the pattern and the border within the milling material 101. The milling material 101 is pulled through the roll nip 202 by the two counter-rotating rolls 203 and 203′, where the milling material configures a fracture in the structure and is comminuted in the process. A feedback-control device 230 which feedback-controls the vibration intensity and/or the vibration frequency, specifically as a function of at least one input variable such as the rotating vibration of the rolls 203, 203′, vibration of the roll press frame, energy consumption of the vibration device 210, energy consumption of the roll drive, can be provided.

A further alternative design embodiment of the metering slide 211 is illustrated in FIG. 5. The metering slide 211 illustrated here also has fin-shaped extensions 220 which likewise like baffles stand vertically on the surface of the metering slide 211. The extensions 220 direct the vibration energy into the milling material 101. Because the metering slide 211 is variable in terms of its position, the extensions 220 follow the metering slide 211. The extensions 220 are in particular of a triangular construction and on the upward-directed edge have a wear strip 222. The wear strip 222 is constructed from hardened steel or reinforced by overlay welding.

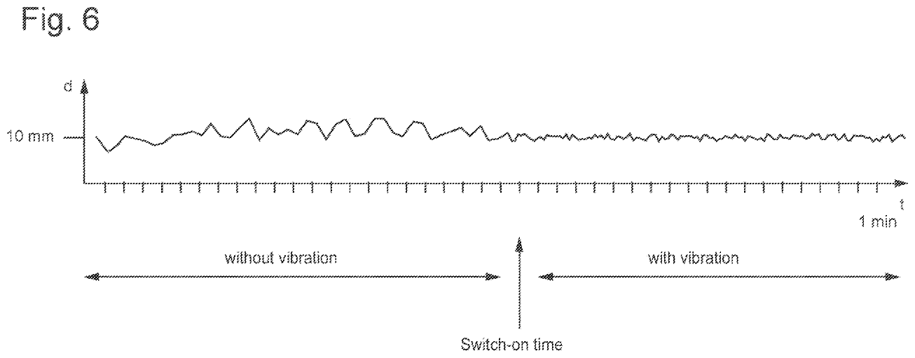

Finally, a diagram in which the roll nip width d of a high-pressure roll press in operation is illustrated over the time t is illustrated in FIG. 6. In the absence of vibrations of the vibration device, the rolls are subjected to significant shocks and vibrate at an amplitude which can no longer be neglected, this being caused by a non-uniform nip. These amplitudes significantly stress the milling roll and are also disadvantageous in terms of the milling efficiency. In the diagram, the vibration device has been switched on after approximately 30 seconds. The roll nip now varies at a significantly lower amplitude and as a result displays significantly smoother running. The smoother running of the rolls causes less stress on the high-pressure roll press, and the smooth running increases the milling efficiency in terms of the energy input and the required number of revolutions of the milling material such that a finer milling material is obtained with less energy input as an end result, the milling material having to pass the high-pressure roll press by way of fewer revolutions.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

100 High-pressure roll press
101 Milling material
102 Roll nip
103 Roll
103′ Roll
104 Feeder device
105 Compaction zone
110 Vibration device
111 Metering slide
120 Extensions
121 Extensions
200 High-pressure roll press
202 Roll nip
203 Roll
203′ Roll
204 Feeder device
205 Compaction zone
210 Vibration device
211 Metering slide
220 Extensions
222 Wear strip
230 Feedback-control device
L Escaping air

1-9. (canceled)

10. A high-pressure roll press for high-pressure comminution of milling material in a roll nip, comprising:
two counter-rotating rolls which therebetween configure the roll nip through which the milling material to be comminuted passes during comminution under high pressure, in a process configuring in the roll nip a fracture in a structure of the milling material; and
a feeder device which feeds the milling material uniformly onto the roll nip at a feeding location, wherein a volume of the fed milling material configures a compaction zone which extends from approximately the center of the roll nip to just beyond a center of the roll nip;
wherein a device for pre-compacting the milling material, formed as a vibration device, is disposed above the compaction zone and extends to close to the compaction zone;
wherein a metering slide is configured to adjust the feeding location on the roll nip and a quantity of the milling material fed onto the roll nip and is disposed within the feeder device;
wherein the vibration device is connected to the metering slide; and
wherein the metering slide directs a vibration energy of the vibration device into the compaction zone.

11. The high-pressure roll press as claimed in claim 10, wherein fin-shaped extensions which direct the vibration energy into the compaction zone are disposed on a side of the metering slide that faces the milling material.

12. The high-pressure roll press as claimed in claim 11, wherein the fin-shaped extensions on the side of the metering slide that faces the milling material, on an upward-directed side of the extensions, have a wear strip constructed from hardened steel or overlay welding.

13. The high-pressure roll press as claimed in claim 10, wherein the vibration device operates at a frequency between 10 Hz and 150 Hz, and performs an energy input of between 0.1 KJ/m³ and 10 KJ/m³ into the milling material.

14. The high-pressure roll press as claimed in claim 13, wherein the vibration device operates at a frequency between 10 Hz and 60 Hz, and performs an energy input of between 0.1 KJ/m³ and 1.0 KJ/m³ into the milling material.

15. The high-pressure roll press as claimed in claim 10, wherein the vibration device has a feedback-control device which feedback-control device controls a vibration intensity based on an energy consumption for operation, wherein an increased energy consumption results in a reduction of the vibration intensity, and a reduced energy consumption results in an increase of the vibration intensity.

16. The high-pressure roll press as claimed in claim 15, wherein the feedback-control device additionally feedback-controls based on an energy consumption of a roll drive of the two counter-rotating rolls, wherein an increased energy consumption of the roll drive results in a reduction of the vibration intensity, and a reduced energy consumption results in an increase of the vibration intensity.

17. The high-pressure roll press as claimed in claim 15, wherein the vibration device is additionally feedback-controlled based on a nip width between the two counter-rotating rolls, wherein an increased nip width results in an increase of the vibration intensity, and a reduced nip width results in a reduction of the vibration intensity.

18. The high-pressure roll press as claimed in claim 16, wherein the vibration device is additionally feedback-controlled based on the vibration intensity of the two counter-rotating rolls, wherein the vibration intensity is increased as a vibration amplitude increases or a selected linear combination of vibration frequency shares increases, and vice versa.

19. The high-pressure roll press as claimed in claim 10, wherein a manual actuation device is provided for the vibration device.
